(19) United States
(12) Patent Application Publication
(10) Pub. No.: US 2026/0132860 A1
(43) Pub. Date: May 14, 2026

(54) PRESSURE REGULATOR

(71) Applicant: Eaton Intelligent Power Limited, Dublin (IE)

(72) Inventor: Niall Joseph Murphy, Orchard Park, NY (US)

(73) Assignee: Eaton Intelligent Power Limited, Dublin (IE)

(21) Appl. No.: 18/947,283

(22) Filed: Nov. 14, 2024

Related U.S. Application Data
(60) Provisional application No. 63/599,634, filed on Nov. 16, 2023.

(51) Int. Cl. F16K 17/06; F16K 3/18; F16K 17/04

(52) U.S. Cl. CPC F16K 17/06; F16K 3/188; F16K 17/044; F16K 17/0493; F16K 2200/302; F16K 2200/304

(57) ABSTRACT

A pressure regulator manages fluid pressure along a pathway between an inlet port and an outlet port. A poppet opens and closes the pathway within the regulator. In certain regulators, a biasing member biases the poppet in common direction with the inlet port. In certain regulators, the poppet defines a through passage to route the fluid past the biasing member. In certain regulators, an adjustment interface arrangement enables a user to set what fluid pressure level closes the pathway by changing a pre-load applied to the poppet.

### BACKGROUND

Some components function best when a constant fluid pressure is maintained at the component. Accordingly, a pressure regulator can be disposed along a fluid pathway to regulate the pressure. Certain types of pressure regulators are manufactured to maintain a predetermined amount of pressure. For example, the pressure regulator may include a spring-biased poppet. The amount of fluid pressure needed to open or close the poppet depends on the spring force applied to the poppet. Improvements are desired.

### SUMMARY

A pressure regulator is configured to receive fluid (e.g., gas) at an inlet port and to transfer at least a portion of the fluid to an outlet port. The pressure regulator selectively opens and closes a pathway between the inlet and outlet ports to regulate a fluid pressure at the outlet port. In accordance with certain aspects of the disclosure, the fluid pressure is regulated by a poppet that selectively seals part of the pathway.

In certain implementations, the inlet port receive the fluid along a first direction and the poppet is biased to the open position along the first direction. In certain examples, the biasing member that biases the poppet in the first direction is not accessible to a technician without dismantling/disabling the regulator.

In certain implementations, the poppet defines a fluid passage away from the outlet ports. Fluid passing along the fluid passage acts on the poppet to move the poppet to the closed position.

In certain implementations, the amount of fluid pressure needed to move the poppet to the closed position is adjustable without dismantling/disabling the regulator. In certain examples, the fluid pressure needed to close the pathway is adjustable from an exterior of the housing. In certain examples, the threshold fluid pressure is adjusted by moving a stop (e.g., a spring stop) within the regulator to change a biasing force applied by a pre-load member within the regulator.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example pressure regulator configured in accordance with the principles of the present disclosure;

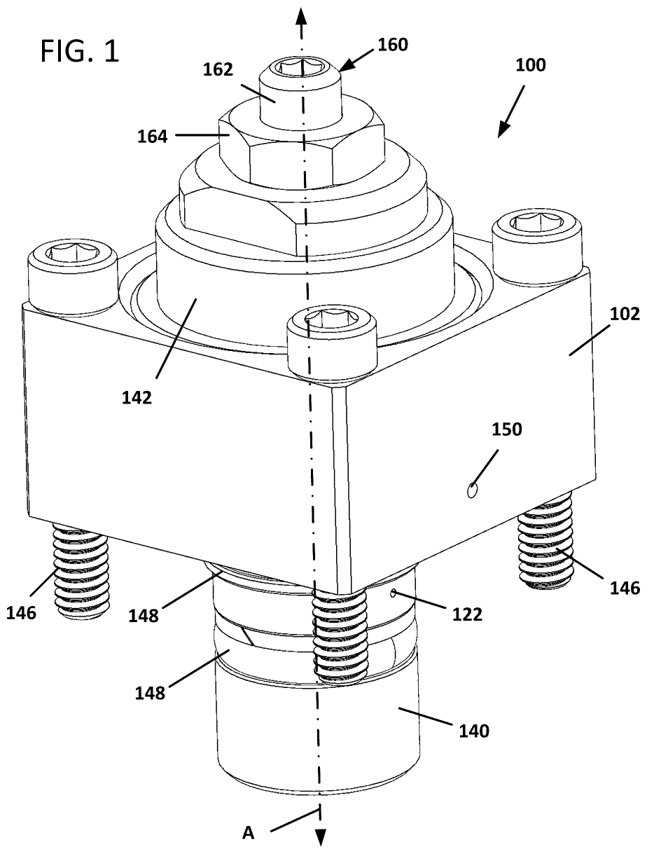

FIG. 2 is an axial cross-section taken of the pressure regulator of FIG. 1 with a poppet disposed in an open position;

FIG. 3 is the same axial cross-section as FIG. 2 with different components labeled for convenience and legibility; and

FIG. 4 is an axial cross-section taken of the pressure regulator of FIG. 1 with the poppet disposed in a closed position.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

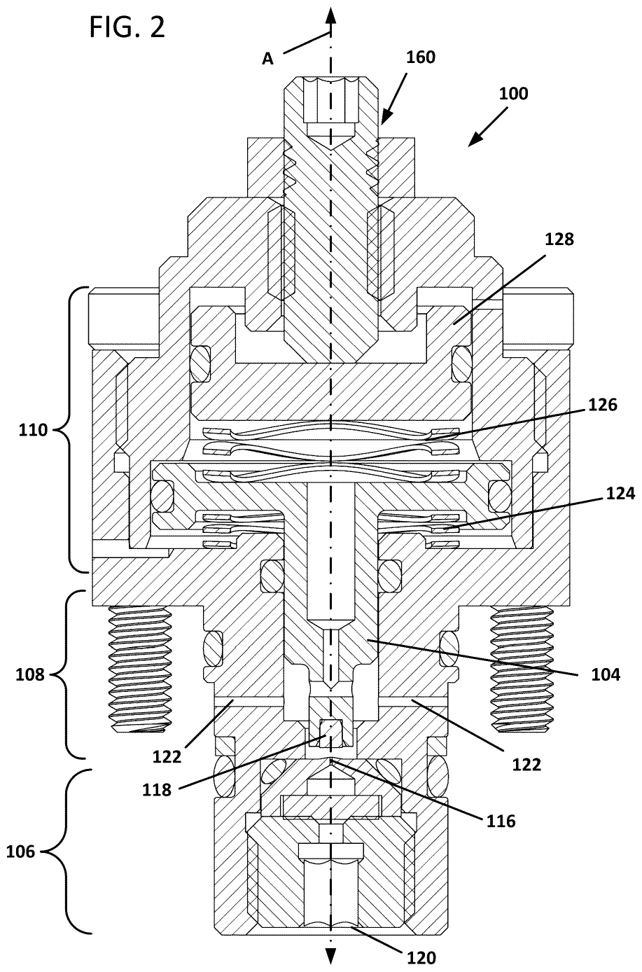

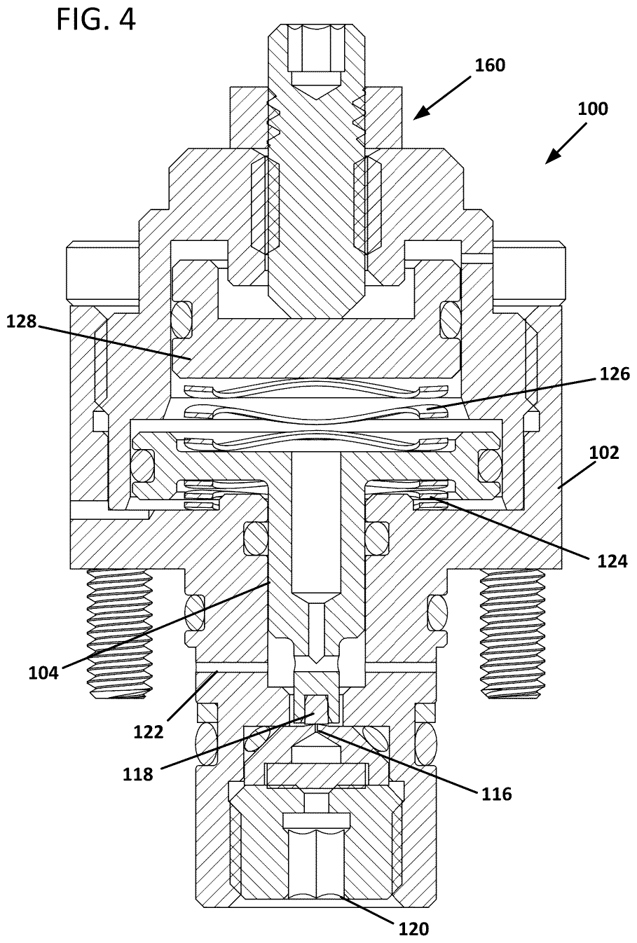

A pressure regulator 100 includes a housing 102 and a poppet 104 movable within the housing 102 along a longitudinal axis A between an open position (e.g., see FIG. 2) and a closed position (e.g., see FIG. 4). The housing 102 defines an inlet region 106 and an outlet region 108. The inlet region 106 defines an inlet port 120 leading from an exterior of the housing 102 to the inlet region 106. The outlet region 108 defines one or more outlet ports 122 leading from the outlet region 108 to an exterior of the housing 102. The housing 102 defines a passage 116 between the inlet region 106 and the outlet region 108. The poppet seals the passage 116 when disposed in a closed position. The poppet opens the passage 116 when moved towards the open position.

In some implementations, the poppet 104 carries a seal 118 that presses against one end of the passage 116 when the poppet 104 is disposed in the closed position. In such implementations, the poppet 104 moves the seal 118 to a location spaced from the passage 116 when the poppet 104 moves towards the open position. In other implementations, the seal 118 is fixedly mounted around the passage 116 and the poppet 104 presses against the seal 118 when the poppet is disposed in the closed position. In such implementations, the poppet 104 moves away from the seal 118 when moved toward the open position.

The housing 102 also defines a regulating region 110. The poppet 104 defines a pathway 136 from the outlet region 108 to the regulating region 110. Accordingly, as fluid flows from the inlet region 106 to the outlet region 108 through passage 116, a portion of the fluid also flows along the pathway 136 to the regulating region 110. The fluid collected in the regulating region 110 acts on the poppet 104 to move the poppet 104 to the closed position. In certain examples, the pressure of the fluid within the regulating region 110 acts in an opposite direction from the pressure of the fluid within the inlet region 106.

In certain implementations, the poppet 104 is biased towards the open position. For example, a biasing member 124 (e.g., one or more wave springs, a coil spring, etc.) may be disposed in the regulating region 110 to bias the poppet 104 towards the open position. The passage 116 is closed when the fluid in the regulating region 110 builds up sufficient pressure to counteract the bias of the biasing member 124. As will be described in more detail herein, the biasing member 124 may be inaccessible without dismantling the housing 102.

In certain implementations, the poppet 104 can be pre-loaded towards counter-acting the bias of the biasing member 124. For example, the biasing member 124 can be a first biasing member while a second biasing member 126 is disposed within the regulating region 110 to bias the poppet 104 towards the closed position. The second biasing member 126 is configured to apply less force than the first biasing member 124. Accordingly, the poppet 104 moves to the closed position only when fluid pressure within the regulating region 110 is sufficient to supplement the biasing force of the second biasing member 126 to overcome the biasing force of the first biasing member 124.

In certain implementations, the pre-load force applied to the poppet 104 is adjustable. For example, the second biasing member 126 is braced against a stop 128 disposed within the regulating region 110. The biasing force of the second biasing member 126 is proportional to the position of the stop 128 within the regulating region 110. As the stop 128 is moved closer to the poppet 104, the biasing force of the second biasing member 126 increases. As the stop 128 is moved away from the poppet 104, the biasing force of the second biasing member 126 is reduced.

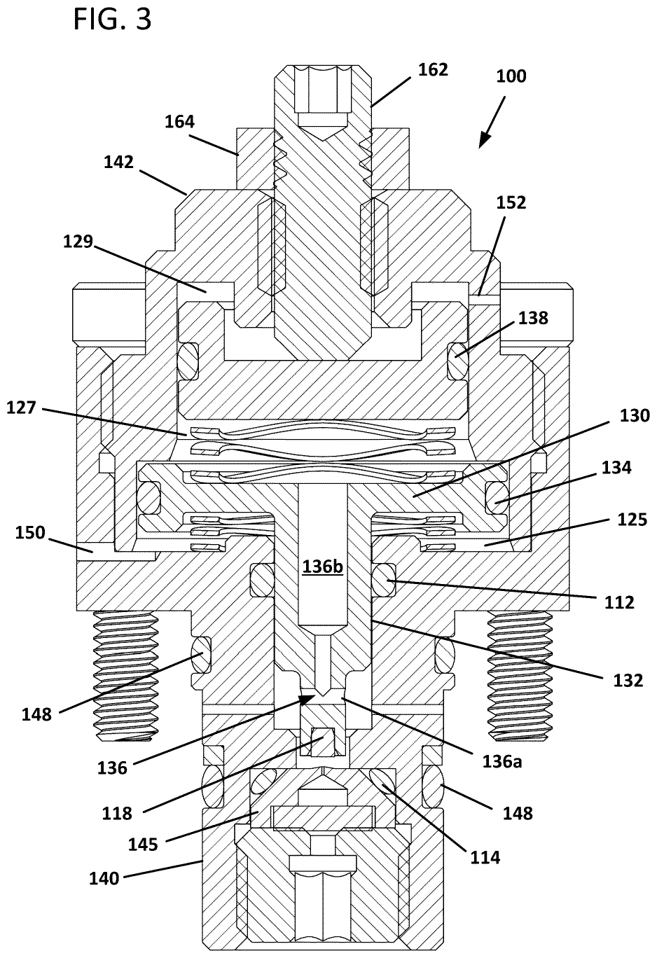

The position of the stop 128 is adjustable within the regulating region 110 using a manual adjustment interface arrangement 160. In certain implementations, accessible from an exterior of the housing 102. In certain implementations, the adjustment interface arrangement 160 extends from a first end contacting the stop 128, through the housing 102, to a second end external of the housing 102. In some implementations, the adjustment interface arrangement 160 is twistable to shift the position of the stop 128. For example, the adjustment interface arrangement 160 may include a threaded rod 162 and nut (e.g., jam nut) 164 (e.g., see FIG. 3). In other implementations, the adjustment interface arrangement 160 can shift the position of the stop 128 through a sliding motion or another type of movement.

In certain examples, the inlet region 106, the outlet region 108, and the regulating region 110 are aligned along the longitudinal axis A. In certain implementations, the outlet region 108 is disposed between the inlet region 106 and the regulating region 110. In some examples, the inlet port 120 faces along the longitudinal axis A. In other examples, the inlet port 120 can be radial, tangential, or otherwise angled relative to the longitudinal axis A. In certain implementations, the passage 116 is sufficiently small that pressure from fluid passing through the passage 116 from the inlet region 106 to the outlet region 108 has little affect on the movement of the poppet 104. Rather, a majority of the force applied to the poppet 104 to move the poppet 104 towards the open position is applied by the first biasing member 124.

In certain implementations, the one or more outlet ports 122 each define a channel extending radially outwardly from the outlet region 108. In the example shown, the housing 102 defines two outlet ports 122 extending in opposite directions. Other outlet port configurations are possible. For example, the outlet ports 122 may be tangential, parallel, or otherwise angled relative to the longitudinal axis A.

As shown in FIG. 3, the housing 102 includes a first housing 140 and a second housing 142. The first housing 140 defines the inlet region 106. In certain examples, the first housing 140 also defines the outlet ports 122. The second housing 142 holds the stop 128 and the adjustment interface arrangement 160. The poppet 104 is sandwiched between the first and second housings 140, 142. In some implementations, the first and second housings 140, 142 are latched, threaded, fastened, or otherwise removably coupled together. In other implementations, the first and second housings 140, 142 are welded or otherwise non-removably fastened together.

In certain implementations, the pressure regulator 100 is configured to mount to a manifold (not shown). The manifold defines an inlet pathway leading to the inlet port 120 and defines one or more outlet pathways leading away from the one or more outlet ports 122. The manifold may connect a high pressure storage tank to a thruster or other component needing a regular source of pressure. The pressure regulator 100 is positioned along the manifold to regulate how much fluid pressure from the inlet pathway is transferred to the outlet pathway.

In certain implementations, the pressure regulator 100 is configured to releasably mount to the manifold. For example, the housing 102 may be configured to mount to the manifold using one or more fasteners 146. In certain examples, the fasteners 146 may extend through the first housing 140. In certain implementations, housing 102 may be configured to seal to the manifold. For example, the housing 102 may carry one or more radial seals 148. In the example shown, two radial seals 148 are disposed at an exterior of the first housing 140 and spaced along the longitudinal axis so that the seals 148 are disposed at opposite sides of the outlet ports 122. In other implementations, the fasteners 146 and/or the seals 148 may be carried by the second housing 142.

In certain implementations, the poppet 104 is disposed partially in the regulating region 110 and partially in the outlet region 108. In certain implementations, the poppet 104 includes a disc portion 130 disposed in the regulating region 110 and a stem portion 132 that extends into the outlet region 108. In certain examples, the first biasing member 124 presses against the disc portion 130 of the poppet 104. In certain examples, the biasing member 124 is disposed presses the disc portion 130 in a common direction with fluid passing through the passage 116 from the inlet region 106 to the outlet region 108. In certain examples, the first housing 140 defines a recessed floor on which the first biasing member 124 seats with the disc portion 130 of the poppet 104 mounted over the first biasing member 124.

In certain implementations, the seal 118 is carried by the stem portion 132. In certain examples, the seal 118 is carried at an axial end of the stem portion 132. In certain implementations, an internal seal 112 seals between the stem portion 132 and the first housing 140 to seal off the outlet region 108 from the regulating region 110 except for the passage 136. In certain implementations, the stem portion 132 defines the passage 136 that extends between the outlet region 108 and the regulating region 110. In certain examples, the passage 136 has a radial segment 136a and an axial segment 136b. In an example, the radial segment 136a aligns with the outlet ports 122 when the poppet 104 is disposed in the closed position. In certain examples, the axial segment 136b widens out as the axial segment 136b extends towards the regulating region 110.

In certain implementations, the poppet 104 seals to the housing 102 at seal 134 to sub-divide the regulating region 110 into a first sub-region 125 and a second sub-region 127. For example, the disc portion 130 of the poppet 104 may carry a radial seal 134 (e.g., an o-ring) that slides against the housing 102 (e.g., to the second housing 142) as the poppet 104 moves open and closed. In certain examples, the first biasing member 124 is disposed in the first sub-region 125 and the second biasing member 126 is disposed in the second sub-region 127. The passage 136 leads to the second sub-region 127. A vent 150 leads out from the first sub-region 125 to an exterior of the housing 102. In certain examples, the vent 150 enables any fluid leaking from the second sub-region 127 to the first sub-region 125 to leave the pressure regulator 100 to inhibit any buildup of pressure within the first sub-region 125. In certain examples, the vent 150 ensures that the fluid pressure contained in the first sub-region 125 is equivalent to the ambient pressure. Accordingly, the fluid pressure in the second sub-region 127 required for the poppet 104 to move to the closed position remains constant with respect to the ambient pressure.

In certain implementations, the stop 128 seals to the housing 102 at seal 138 to further section out a third sub-region 129. One axial end of the stop 128 at least partially bounds the second sub-region 127 and the opposite axial end of the stop 128 at least partially bounds the third sub-region 129. Moving the stop 128 axially within the regulating region 110 changes the size of the second and third sub-regions 127, 129. Reducing the size of the second sub-region 127 compresses or further compresses the second biasing member 126. Accordingly, less fluid pressure needs to build up within the second sub-region 127 of the regulating region 110 to counteract the biasing force of the first biasing member 124 and thereby move the poppet 104 to the closed position. In certain examples, a vent 152 leads out from the third sub-region 129 to an exterior of the housing 102.

In some examples, the first passage 116 is defined by the first housing 140. In other examples, the first passage 116 is defined by an insert arrangement 145 disposed within a cavity defined in the first housing 140. The insert arrangement 145 is sealed to an interior of the first housing 140 at a seal 114 (e.g., an axial seal, a radial seal, etc.). In certain examples, the insert arrangement 145 is formed of multiple pieces that can be assembled within the cavity of the first housing 140.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A pressure regulator comprising:
a housing defining an inlet region, an outlet region, and a regulating region, the inlet and outlet regions being separated by a first passage, the inlet region being configured to receive inlet pressure along a first direction;
a poppet disposed within the housing, the poppet extending along a length between first and second ends, the first end being disposed at the outlet region and the second end being disposed at the regulating region, the poppet being movable relative to the housing between open and closed positions, the poppet sealing closed the first passage when the poppet is disposed in the closed position and the poppet opening the first passage when the poppet is moved towards the open position, the poppet defining a second passage fluidly connecting the outlet region and the regulating region; and
a first biasing member biasing the poppet along the first direction towards the open position.

2. The pressure regulator of claim 1, wherein the poppet carries a seal that presses against a valve seat surrounding the passage when the poppet is disposed in the closed position, and wherein the seal is spaced from the valve seat when the poppet is disposed in the open position.

3. The pressure regulator of claim 1, further comprising:
a stop disposed at the regulating region; and
a second biasing member disposed between the stop and the poppet, the second biasing member being weaker than the first biasing member.

4. The pressure regulator of claim 3, wherein the poppet includes a stem extending outwardly from a disc, and wherein the first and second biasing member are disposed at opposite sides of the disc.

5. The pressure regulator of claim 3, wherein the stop is selectively positionable within the regulating region.

6. The pressure regulator of claim 5, further comprising an adjustment interface arrangement configured to selectively position the stop within the regulating region.

7. The pressure regulator of claim 6, wherein the adjustment interface arrangement is twistable to select the position of the stop.

8. The pressure regulator of claim 1, wherein the inlet region, the outlet region, and the regulating region are aligned along a longitudinal axis of the housing, and wherein the poppet moves relative to the housing along the longitudinal axis.

9. The pressure regulator of claim 1, wherein the housing defines an outlet port at the outlet region, the outlet port facing in a different direction from the inlet port.

10. A method of operating a pressure regulator comprising:
directing gas through an inlet of the pressure regulator along a first direction;
directing gas through a passage to an outlet region of the pressure regulator;
directing a first portion of the gas within the outlet region out of the pressure regulator through an outlet;
directing a second portion of the gas within the outlet region through a poppet to a regulating region;
applying a closing force to the poppet using the second portion of the gas, the closing force being applied in a second direction that is opposite the first direction.

11. The method of claim 10, further comprising applying a biasing force to the poppet along the first direction; and applying a pre-load force the poppet along the second direction.

12. The method of claim 11, further comprising adjusting the pre-load force applied to the poppet.

13. The method of claim 12, wherein adjusting the pre-load force includes rotating an adjuster from an exterior of the pressure regulator.

14. A pressure regulator comprising:
a housing defining an inlet region, an outlet region, and a regulating region, the housing also defining a passage between the inlet region and the outlet region;
a poppet disposed within the housing, the poppet being movable relative to the housing along an axis between open and closed positions, the poppet sealing closed the passage when the poppet is disposed in the closed position and the poppet opening the passage when the poppet is moved towards the open position; and
a first biasing member biasing the poppet to the open position;
a stop disposed at the regulating region, the stop being selectively positionable along the axis within the regulating region; and
a second biasing member disposed between the stop and the poppet.

15. The pressure regulator of claim 14, wherein the poppet separates at least a portion of the regulating region into first and second regions, the poppet carrying a radial seal that seals the second region from the first region, the first biasing member being disposed in the first region, and the second biasing member being disposed in the second region.

16. The pressure regulator of claim 15, further comprising a first vent fluidly connecting the first region to ambient.

17. The pressure regulator of claim 15, wherein the regulating region also has a third region, wherein the stop has a second radial seal that separates the third region from the second region.

18. The pressure regulator of claim 17, further comprising a second vent fluidly connecting the third region to ambient.

19. The pressure regulator of claim 14, further comprising an adjustment rod that extends through the housing, the adjustment rod contacting the stop to position the stop within the regulating region.

20. The pressure regulator of claim 19, wherein the adjustment rod is rotatably actuated to adjust the position of the stop along the axis of the housing.
